(19) United States
(12) Patent Application Publication
(10) Pub. No.: US 2024/0087056 A1
(43) Pub. Date: Mar. 14, 2024

(54) METHOD FOR ASSISTING USER IN CARING FOR PLANT, COMPUTER SYSTEM AND STORAGE MEDIUM

(71) Applicant: Hangzhou Ruisheng Software Co., Ltd., Zhejiang (CN)

(72) Inventors: Qingsong Xu, Zhejiang (CN); Qing Li, Zhejiang (CN)

(73) Assignee: Hangzhou Ruisheng Software Co., Ltd., Zhejiang (CN)

(21) Appl. No.: 18/518,564

(22) Filed: Nov. 23, 2023

Related U.S. Application Data
(63) Continuation of application No. PCT/CN2023/079445, filed on Mar. 3, 2023.

(30) Foreign Application Priority Data
Mar. 28, 2022 (CN) 202210310975.9

(51) Int. Cl. G06Q 50/02; A01G 7/06

(52) U.S. Cl. CPC G06Q 50/02; A01G 7/06

(57) ABSTRACT

The present disclosure relates to a computer-executable method for assisting a user in caring for a plant. The method comprises: identifying the species and growth stage of a plant in a picture by a plant recognition model, and generating a caring plan for the plant based on the species and the growth stage; recognizing a health state of the plant in the picture by a health detection model, and adjusting the caring plan based on the health state; and according to the adjusted caring plan, outputting a prompt regarding the execution of a corresponding caring task at a predetermined time.

### CROSS-REFERENCE TO RELATED APPLICATION

This application is a continuation of international PCT application serial no. PCT/CN2023/079445, filed on Mar. 3, 2023, which claims priority benefit of China patent application No. 202210310975.9 filed on Mar. 28, 2022. The entirety of each of the abovementioned patent applications is hereby incorporated by reference herein and made a part of this specification.

### BACKGROUND

### Technical Field

The disclosure relates to the field of computer technology, and in particular, relates to a method for assisting a user in caring for a plant and a computer system.

### Description of Related Art

People often place some plants in their homes or offices, and these plants need to be cared for regularly, such as watering, fertilizing, pruning, pest control, etc. Taking watering as an example, different plants have different water needs and require different watering frequencies. Especially when there are many species of plants that need to be cared for, it may be difficult for people to accurately remember the caring task required by each plant and the time when the task needs to be performed.

### SUMMARY

The disclosure aims to provide a method for assisting a user in caring for a plant and a computer system.

According to the first aspect of the disclosure, the disclosure provides a computer-executable method for assisting a user in caring for a plant, and the method includes the following steps. A species and a growth stage of a plant in a picture is identified by a plant recognition model, and a caring plan for the plant is generated on the basis of the species and the growth stage. A health state of the plant in the picture is recognized by a health detection model, and the caring plan is adjusted on the basis of the health state. According to the adjusted caring plan, a prompt regarding execution of a corresponding caring task is outputted at a predetermined time.

According to the second aspect of the disclosure, the disclosure further provides a computer system for assisting a user in caring for a plant, and the computer system includes one or a plurality of processors and one or a plurality of storages configured to store a series of computer-executable commands. When the series of computer-executable commands are executed by the one or the plurality of processors, the one or the plurality processors are enabled to perform the method according to the above.

According to the third aspect of the disclosure, the disclosure further provides a non-transitory computer-readable storage medium storing a series of computer-executable commands. When the series of computer-executable commands are executed by one or a plurality of computing devices, the one or the plurality computing devices are enabled to perform the method according to the above.

Other features of the disclosure and advantages thereof will become apparent from the following detailed description of exemplary embodiments of the disclosure with reference to the accompanying drawings.

### BRIEF DESCRIPTION OF THE DRAWINGS

The accompanying drawings, which form a part of the specification, illustrate embodiments of the disclosure and together with the description serve to explain the principles of the disclosure.

The disclosure may be more clearly understood from the following detailed description with reference to the accompanying drawings described as follows.

FIG. 1 is a flow chart schematically illustrating at least part of a computer-executable method for assisting a user in caring for a plant according to an embodiment of the disclosure.

FIG. 2 is a schematic picture schematically illustrating a display screen provided by an application program of the method according to an embodiment of the disclosure.

FIG. 3A to FIG. 3C are schematic pictures schematically illustrating the display screens provided by the application program of the method according to an embodiment of the disclosure.

FIG. 4A and FIG. 4B are schematic pictures schematically illustrating the display screens provided by the application program of the method according to an embodiment of the disclosure.

FIG. 5A to FIG. 5I are schematic pictures schematically illustrating recognition of caring locations by a planting environment recognition model in the method according to an embodiment of the disclosure.

FIG. 6 is a schematic diagram schematically illustrating intelligent adjustment of dates of a caring task in the computer-executable method for assisting the user in caring for the plant according to an embodiment of the present disclosure.

FIG. 7 is a structural view schematically illustrating at least part of a computer system for assisting a user in caring for a plant according to an embodiment of the disclosure.

FIG. 8 is a structural view schematically illustrating at least part of a computer system for assisting a user in caring for a plant according to an embodiment of the disclosure.

Note that in the embodiments described below, the same reference numerals are used in common between different accompanying drawings to denote the same parts or parts having the same function, and repeated description thereof is omitted. In this specification, similar numbers and letters are used to denote similar items, and therefore, once an item is defined in one figure, it does not require further discussion in subsequent figures.

### DESCRIPTION OF THE EMBODIMENTS

Various exemplary embodiments of the disclosure are described in detail below with reference to the accompanying drawings. It should be noted that the relative arrangement of the components and steps, the numerical expressions and numerical values set forth in these embodiments do not limit the scope of the disclosure unless specifically stated otherwise. In the following description, in order to better explain the disclosure, numerous details are set forth, however it will be understood that the disclosure may be practiced without these details.

The following description of at least one exemplary embodiment is merely illustrative in nature and is in no way intended to limit the disclosure, its application or uses in any way. In all examples shown and discussed herein, any specific value should be construed as illustrative only and not as limiting.

Techniques, methods, and apparatuses known to a person having ordinary skill in the art may not be discussed in detail, but where appropriate, such techniques, methods, and apparatuses should be considered part of the specification.

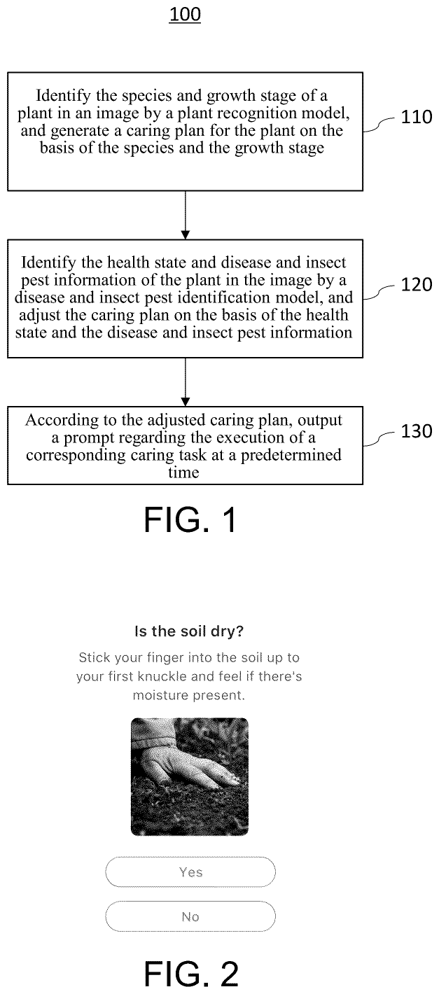

With reference to FIG. 1, which is a flow chart of a computer-executable method 100 for assisting a user in caring for a plant according to an embodiment of the disclosure. The method 100 may be implemented by an application program to provide the user with auxiliary functions of caring for the plant, for example, reminding the user to perform a corresponding caring task at a predetermined time. The application program may be installed on an electronic apparatus such as a computer, a mobile phone, etc. The method 100 may include: identifying a species and a growth stage of a plant in a picture by a plant recognition model and generating a caring plan for the plant on the basis of the species and the growth stage (step 110); recognizing the plant in the picture by a health detection model, so as to determine a health state of the plant, and adjusting the caring plan on the basis of the health state (step 120); and according to the adjusted caring plan, outputting a prompt regarding execution of a corresponding caring task at a predetermined time (step 130).

Identification may be made on the basis of the received picture containing the plant. It should be understood that the picture referred to in the specification may be a static or dynamic picture, a video, etc. The received picture may be a picture taken by the user (including a picture taken in the current application program and a picture taken outside the current application program) at present, and may also be a picture that the user wishes to identify but is not taken by the user at present, such as a picture from an entity such as the Internet, other users, or other devices.

In step 110, the species and the growth stage of the plant are identified by the plant recognition model. The plant recognition model may be a, for example, a neural network model established through sample training in advance, such as a convolutional neural network model or a residual network model. The same recognition model may be used to identify the species and the growth stage of the plant together, or two separate models may be used to identify the species and the growth stage of the plant separately. The growth stage may include one of a seed/seedling stage, a growing stage, a flowering stage, a fruiting stage, a dormant stage, and a drying stage. In step 110, the caring plan for the plant is generated on the basis of the species and the growth stage of the plant. The caring plan includes one or a plurality of caring tasks for the plant and a frequency (herein referred to as a “plan execution frequency”) at which each task shall be performed in the plan.

The caring tasks may include, for example, at least one of watering, spraying water, changing water, adding water, fertilizing, changing soil, pruning, weeding, repotting, pot changing, sunlight, shading, adjusting temperature, adjusting humidity, winter protection, applying pesticides, and applying fungicides. Each task may also have subcategories, such as the fertilizing task, which may include subcategories such as applying slow-release fertilizer, water-soluble fertilizer, liquid fertilizer, etc. Different subcategories may be performed at different frequencies. Breaking down each caring task into subcategories allows for more precise planning of appropriate care for the plant. The subcategories of the suggested caring tasks may be determined based on the species and the growth stage of the plant or may be determined based on preferences inputted by the user. It should be noted that when the “caring tasks” are mentioned in this specification and the appended claims, it may include the abovementioned and similar caring tasks and may also include the subcategories of the caring tasks.

In addition to the abovementioned caring tasks that may be performed periodically, the caring tasks may also include short-term tasks recommended based on a growth state and a planting environment of the plant at present. For instance, a soil type in which the plant is currently grown may be identified, and if it is determined that the soil type is unsuitable for the species or the growth stage of the plant at present, a short-term task to improve the soil may be suggested. A pruning state of the plant at present may be identified and short-term tasks regarding whether pruning is needed and how pruning can be performed may be suggested. It can also identify whether the growth stage of the plant at present is suitable for harvesting and, if so, short-terms regarding when and how to harvest may be suggested.

It should be noted that not every plant requires all of the abovementioned caring tasks. Some caring tasks may be related to the species of plants. For instance, for a specific species of plants, daily caring does not require watering, so only the water spraying task may be prompted. Some caring tasks may be related to the growth stage of plants, such as the pot-changing task, which may be only for plants in the growth stage, flowering stage, or fruiting stage. Some caring tasks may be season-related. For instance, some plants do not need watering in winter, or the watering task needs to be performed very infrequently. Therefore, in some embodiments, a caring plan for the plant may be generated on the basis of the species, the growth stage, and the seasons.

For instance, a task frequency lookup table as shown in Table 1 below may be established in advance. The value in each unit in the table represents the plan execution frequency of each caring task, which is reflected in the table as the number of days between plan executions. For instance, the corresponding caring task for plant species 1 in growth stage 2 shall be executed every 17 days. The absence of a value in a unit indicates that this task does not need to be performed on the corresponding plant species in the corresponding growth stage. For instance, this task does not need to performed on plant species 2 in growth stage 1.

TABLE 1
Task Frequency Lookup Table

| Plan Execution | Growth | Growth | Growth | Growth |
|---|---|---|---|---|
| Interval | Stage 1 | Stage 2 | Stage 3 | Stage 4 |
| Plant Species 1 | 21 | 17 | 14 | 10 |
| Plant Species 2 | — | 14 | 10 | 7 |
| Plant Species 3 | 14 | 10 | 7 | 5 |
| Plant Species 4 | 10 | 7 | 5 | 3 |

In step 120, the plant in the picture is recognized by the health detection model, so as to determine the health state of the plant, and the caring plan is adjusted on the basis of the health state. The health state of the plant may include health, potential health risks, sub-health, minor disease and insect pest damage, and significant disease and insect pest damage. According to different physical examination states, different caring plans may be provided for the user. For instance, if the health state of the plant is identified as minor or significant disease and insect pest damage, a caring task of applying pesticides may be added. In some embodiments, the health state of the plant may also be obtained by asking the user. In some embodiments, if the health state of the plant is identified as minor or significant disease and insect pest damage, a disease and insect pest identification model may also be used to identify specific disease and insect pest information, such as fungal diseases, white powder, coal pollution, rust powder, downy mildew, white silk, etc., so that a caring task regarding disease treatment may thus be added. Each of the health detection model and the disease and insect pest identification model may be, for example, a neural network model pre-trained in advance, such as a convolutional neural network model or a residual network model.

Further, the caring task and its plan execution frequency may also depend on the planting environment of the plant. The planting environment may include the location where the plant is cared for, such as indoors or outdoors, may include the way the plant is planted, such as potted planting or ground planting, soil culture or hydroponics, etc., and may also include caring conditions of the plant, such as light intensity, ambient temperature, or soil moisture. In step 120, the caring plan may also be adjusted according to the planting environment of the plant.

In some embodiments, an interactive question asking for additional information on the planting environment of the plant may be outputted, and the additional information on the planting environment of the plant may be determined based on the received answer to the interactive question, so that the caring plan may be adjusted on the basis of the additional information on the planting environment of the plant. FIG. 2 shows an example of an interactive question. In this example, an interactive question asking for the soil moisture in which the plant is planted is outputted, and an instruction for the user to self-assess the answer to the question is given below the question. In some embodiments, outputting an interactive question asking for the additional information on the planting environment of the plant may include presenting one or a plurality of operable answer options for the interactive question. For example, in the example shown in FIG. 2, the operable answer options of “Yes” and “No” are both provided for the user to operate. The user can make a selection operation based on the actual soil moisture condition. In addition, where a recommended answer option for the interactive question for the plant is present, the recommended answer option may be selected by default. For instance, if it can be identified from the picture that the soil where the plant is planted is relatively dry, the option “Yes” may be selected by default in the interactive question shown in FIG. 2.

In some embodiments, the additional information on the planting environment of the plant in the picture may be recognized by a planting environment recognition model, and the caring plan may be adjusted according to the recognized additional information on the planting environment of the plant. The planting environment recognition model may be, for example, a neural network model pre-trained in advance, such as a convolutional neural network model or a residual network model.

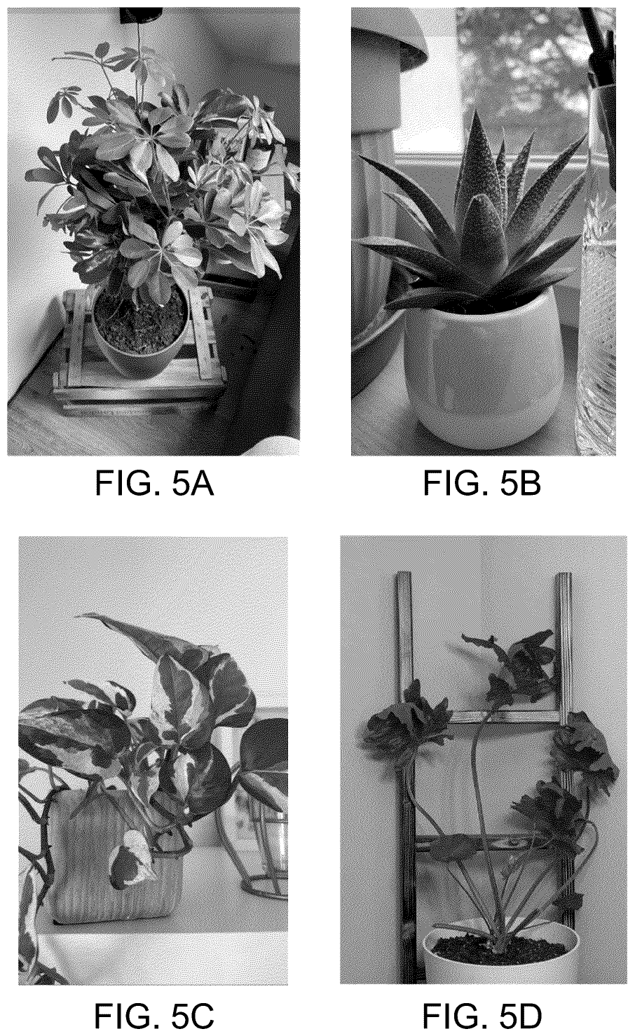

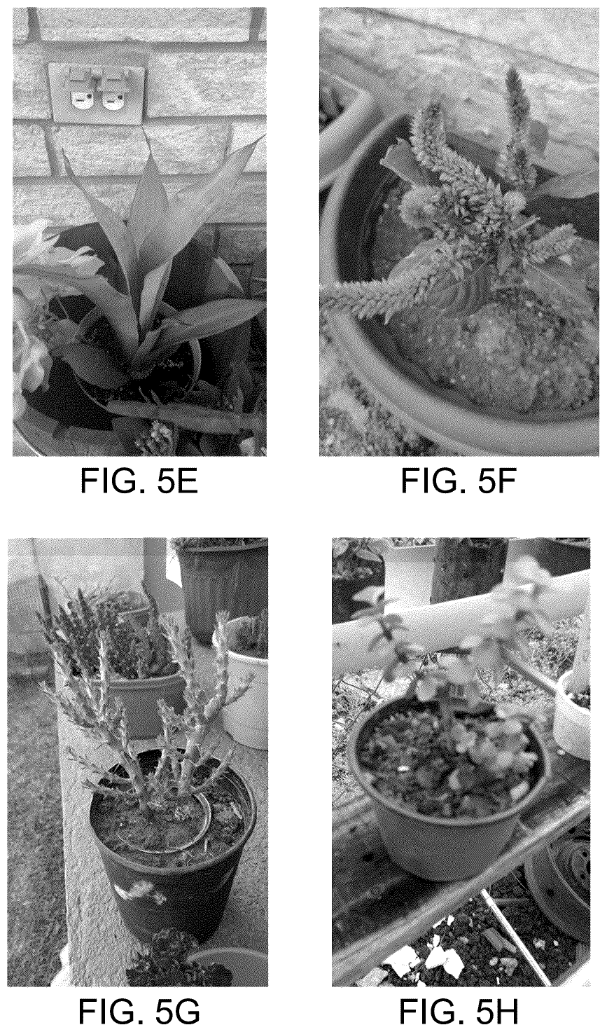

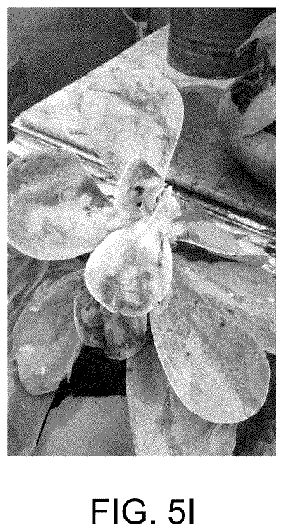

In some embodiments, the planting environment recognition model may recognize a caring location of the plant. FIG. 5A to FIG. 5I are schematic pictures schematically illustrating recognition of caring locations by the planting environment recognition model in the method according to an embodiment of the disclosure. In response to identifying a local feature of presence of furniture (e.g., a table, a stool, a sofa, a television, etc.) and/or a house (e.g., a roof, a floor, a window, etc.) around the plant and identifying an outdoor feature (e.g., a lawn, a large tree, a dirt floor, etc.) near (e.g., immediately adjacent to an outer edge of the local feature of the presence of furniture and/or a house) the local feature of the presence of furniture and/or a house, the caring location is determined to be outdoors, as shown in FIG. 5G and FIG. 5H. In contrast, in response to identifying the local feature of the presence of furniture and/or a house around the plant but not identifying the outdoor feature near the local feature of the presence of furniture and/or a house, the caring location is determined to be indoors, as shown in FIG. 5A to FIG. 5C and FIG. SI. In some embodiments, in the case where the local feature of the presence of furniture and/or a house is not identified but the outdoor feature is identified to be nearby, it can be further identified whether the furniture is indoor furniture or outdoor furniture (e.g., a table, a stool, etc. used in a yard). If it is determined to be outdoor furniture, the caring location is determined to be outdoors. If it is determined to be indoor furniture (as shown in FIG. 5C), or it cannot be determined whether it is indoor furniture or outdoor furniture (as shown in FIG. 5I), the caring location is determined to be indoors. In response to identifying presence of a wall in the picture and identifying the wall as an exterior wall, the caring location is determined to be outdoors, as shown in FIG. 5F. In response to identifying the presence of a wall in the picture but not identifying the wall as an exterior wall, the caring location is determined to be indoors. Failure to identify the wall as an exterior wall includes cases in which the wall is identified as an interior wall, as shown in FIG. 5D, and in which it is impossible to determine whether the wall is an interior wall or an exterior wall, as shown in FIG. 5E.

In addition, regarding the caring location of the plant, indoors may be divided into a living room, a dining room, a bathroom, a bedroom, etc., and outdoor may be divided into a front yard, a backyard, etc. These subdivided different caring locations require different corresponding light, temperature, humidity and other condition factors for plant caring, and these different caring locations are not only suitable for growing different plants, but also may require different caring methods for the same kind of plants. The additional information on these subdivided caring locations may be obtained by outputting interactive questions to the user, and the caring plan may be adjusted more precisely in this way.

As mentioned above, the planting environment of the plant may also include light intensity. Light intensity affects the caring plan as well. For instance, if the light intensity of the plant is not enough, it may be necessary to arrange a caring task of regular supplementary light. The light intensity may be obtained through the method described above according to the various embodiments, for example, including the interactive question and/or the planting environment recognition model. In addition, in response to the user taking a picture, for example when the user takes a picture in an application program that implements the method according to an embodiment of the disclosure, a photometer on a device to which the application program is installed may be called, so that light intensity information of the picture taken by the user is obtained from the photometer.

Further, after the planting environment of the plant is obtained in the manner described above in each embodiment, it can be determined whether the planting environment of the plant is suitable for the plant. In response to the planting environment being unsuitable for the plant, a prompt regarding adjustment of the planting environment is outputted. In an example, in response to the light intensity not being suitable for the plant, for example, there is insufficient light at the current location, a prompt regarding adjustment of the light intensity is outputted. For example, the user is reminded to move the plant to a location with suitable lighting. In an example, a size and/or a material of a planting container of the plant in the picture is identified by a planting container recognition model. In response to the size and/or the material being unsuitable for the plant, a prompt regarding adjustment of the planting container is outputted.

In step 130, according to the adjusted caring plan, a prompt regarding execution of a corresponding caring task at a predetermined time is outputted. The caring plan includes the caring task and the plan execution frequency thereof. A plan execution date of the caring task is determined according to the plan execution frequency of the caring task. According to the plan execution date of the caring task, a prompt regarding execution of the corresponding caring task on a scheduled date is outputted. After the plan execution frequency of the caring task is determined according to the method described above, the plan execution date of the caring task may be determined. For example, the date when a specific task for a specific plant is first performed may be recorded. A date every number of days indicated by the plan execution interval in the task frequency lookup table (e.g., Table 1 as mentioned above) is then determined as the plan execution date of the caring task. The date when the task is first executed may be determined by user input. For instance, the application program may ask the user when pot changing is last performed on the plant. The user may enter a precise date or a fuzzy time such as three months ago, six months ago, one year ago, etc. The application program determines the date on which the pot-changing task for the plant is first performed according to this time. In addition, the application may also set a default date for the task to be executed for the first time. For instance, after the plant is created, a first execution date of one or a plurality of tasks for the plant may be set to the day the plant is created. It should be understood that the “first time” referred to in the specification is relative and refers to the first time relative to other works within a specific period of time. For instance, for a “current task” closest to the current time among the tasks whose execution date is to be determined, its “last task” may be considered as the first task. Correspondingly, for the plurality of tasks whose execution dates are to be determined, the current task whose execution date is closest to the current time may also be considered as the first task.

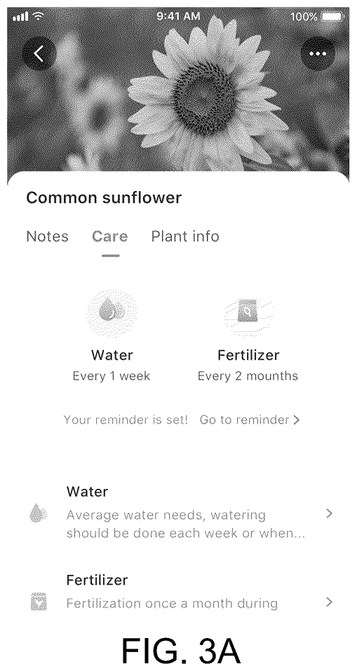

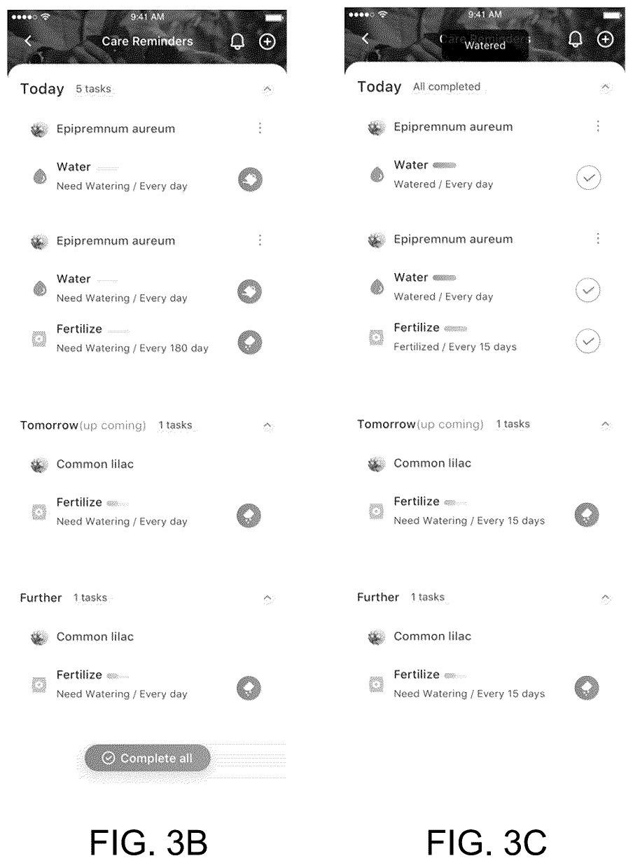

FIG. 3A may be a display screen when a caring plan for the plant is created in the application program. It can be seen that in the caring plan for the plant at the current stage includes two caring tasks, watering and fertilizing. The plan execution frequency of watering is once a week, and the execution frequency of fertilizing is once every two months. FIG. 3B may be a prompt screen of caring tasks outputted by the application program on a specific day. It can be seen that on the current date, the user has two plants requiring caring tasks, one of which needs watering, and the other needs watering and fertilizing. As shown in the figure, in addition to task reminders for the current date, the screen may also include prompts for upcoming tasks, so that the user can best plan his/her time and prepare supplies in advance. After the user completes a specific caring task, the corresponding task may be marked as “completed”, as shown with “√” in FIG. 3C.

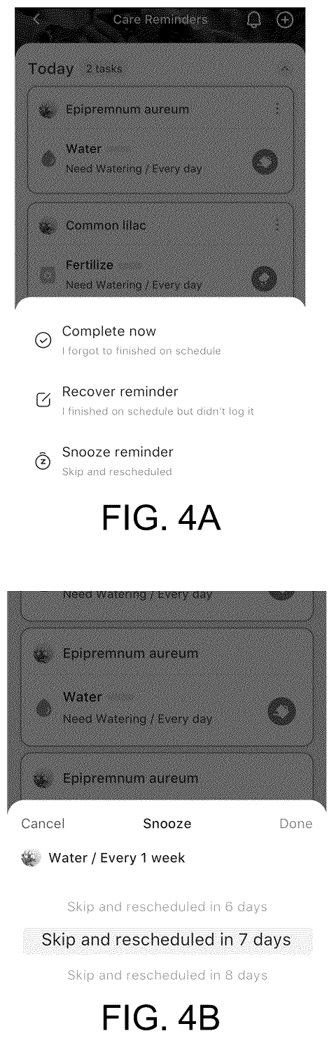

Further, a function is provided to the user to allow the user to perform a delay operation or a skip operation on each caring task, as shown in FIG. 4A. After the user chooses to delay a specific task, the user may also enter the desired number of days to delay, as shown in FIG. 4B, which may be entered in the form of operating options. The application program may reschedule the execution date of the caring task according to the number of days of delay entered by the user. Similarly, the user may also choose to skip the current execution of a specific task, and the application program may adjust the plan execution date of the caring task on the basis of skip information inputted by the user. Further, delaying/skipping also impacts task execution parameters. For instance, if the user chooses to skip this watering task, the watering amount of the next watering task of the plant may be increased.

In order to facilitate the user to perform the caring tasks, the plan execution date of each task in the caring plan may be automatically adjusted. The adjustment goal may include, for example, reducing the number of days that the user needs to perform the task. For example, if a task can be completed in one day, the task is arranged to be done in one day as much as possible. The caring tasks scheduled on the same day may be the same type of caring tasks or may be different types of caring tasks, for example, the caring tasks may include watering and fertilizing. It may also include arranging tasks to be executed on weekends, legal holidays, and other rest days as much as possible. In some embodiments, the method further includes: determining whether the determined plan execution date of the caring task satisfies a condition for adjustment to a target date. If the condition is satisfied, the plan execution date of the caring task is adjusted to the target date. Herein, the target date may be the rest day closest to the plan execution date of the caring task (so that the caring task may be arranged on the rest day as much as possible), a date that does not conflict with the user's schedule (for example, the user's schedule may be learned by calling an application program such as a calendar to schedule the caring task on a date when the user has no outing arrangement), the plan execution date of another caring task whose plan execution date is closest to the plan execution date of the caring task (so that caring tasks that are originally planned to be performed on different dates may be arranged on the same day as much as possible). In some embodiments, the adjusting the plan execution date of the caring task to the target date may include: a plan execution interval indicated by the plan execution frequency of the caring task being greater than 5 days and the number of days between the plan execution date of the caring task and the target date being less than 20% of the plan execution interval. According to these embodiments, for tasks whose plan execution interval is 5 days or less, the plan execution date cannot be adjusted. Tasks with a plan execution interval greater than 5 days may be adjusted, and the adjustment range is less than 20% of the plan execution interval.

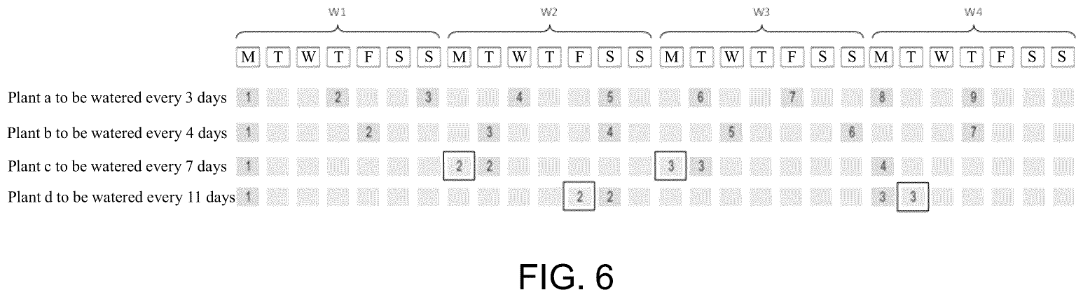

FIG. 6 is a schematic diagram of intelligent adjustment of the dates of caring tasks. The rows correspond to the caring tasks of plants a to d, the columns represent the dates from the first week W1 to the fourth week W4, and the number in each cell represents the n^{th} execution of the corresponding task. The number in the frame represents the initially determined plan execution date, and the same number in the same row represents the target adjustment date of the task. In this specific example, the watering task for plant c is repeated with an interval of 7 days. The date of the second execution may be adjusted from Monday of the second week W2 to Tuesday of the second week W2, so as to be scheduled on the same day as the third watering task of plant b with a repetition interval of 4 days. The date of the third execution of the watering task of plant c may be adjusted from Monday of the third week W3 to Tuesday of the third week W3, so as to be scheduled on the same day as the sixth watering task of plant a with a repetition interval of 3 days. As for the watering task of plant d with a repetition interval of 11 days, the date of the second execution may be adjusted from Friday of the second week W2 to Saturday of the second week W2, so as to arrange the task on the weekend as much as possible, and may be scheduled on the same day as the fifth watering task of plant a and the fourth watering task of plant b. The date of the third execution of the watering task of plant d may be adjusted from Tuesday of the fourth week W4 to Monday of the fourth week W4, so as to be scheduled on the same day as the fourth watering task of plant c and the eighth watering task of plant a.

In some cases, the user may care for multiple plants of the same species. In some embodiments, if the species of the plant currently being planned for caring is consistent with the species of a previous plant for which a caring plan is previously generated, the caring plan for the current plant and the caring plan for the previous plant are merged. Further, according to the merged caring plan, a prompt regarding execution of a corresponding caring task at a predetermined time is outputted. In this way, it is helpful for the user to care for and manage plants of the same type in batches.

In some embodiments, the method may further include: obtaining weather information for a date with the caring task and in addition to outputting the prompt regarding the caring task, outputting the weather information on the caring task and a caring tip for the weather information. The weather information may include sunny/cloudy/rainy/snow conditions, temperature, humidity, etc. In an example, if there is a watering task today, the caring location of the plant is outdoors, and the obtained weather information shows that there is a high probability of precipitation today, in addition to the prompt of the watering task for the plant, a caring tip is also outputted to remind the user that there will be precipitation today, so attention needs to be paid to cancel the watering task or reduce the amount of watering.

In some embodiments, the method may further include: regularly performing a return visit on the user to obtain a current growth state of the plant and adjusting the caring plan according to the current growth state of the plant. Each plant may be set up for regular return visits. A return visit date set for a specific plant may include outputting a return visit question and/or prompting the user to enter an updated picture of the plant. The growth stage of the plant may be recognized through the plant recognition model described above, and/or the health state and the disease and insect pest information of the plant may be identified through the health detection model and the disease and insect pest identification model described above, so that the current growth state of the plant is obtained. The current growth state of the plant may also be recognized through a trained plant current growth state identification model that is separate from the above models. The caring plan for the plant is adjusted according to the current growth state of the plant. In an example, although the user performs watering on time according to the prompt of the watering task, the watering amount may not have been controlled well, resulting in too much or too little watering, which may be reflected in the state of the plant. Therefore, through the updated picture of the plant obtained during the return visit, it can be identified whether the frequency of the watering task needs to be increased or decreased and/or whether the user needs to be reminded to increase or decrease the amount of watering, etc. In an example, through the return visit, it may be found that the plant lacks light, so the user may be reminded to change the caring location or add a caring task, such as regular light supplement, to the caring plan. Similarly, the execution of caring tasks such as fertilization, pest control, and sterilization may also be determined based on the recognition results of the return visit picture (i.e., the current growth state of the plant), and the subsequent caring plan for the plant may be accordingly adjusted. Further, during the return visit, an interactive question may also be outputted for the user to choose to assist the application program in making determination, and the caring plan may thus be more accurately adjusted.

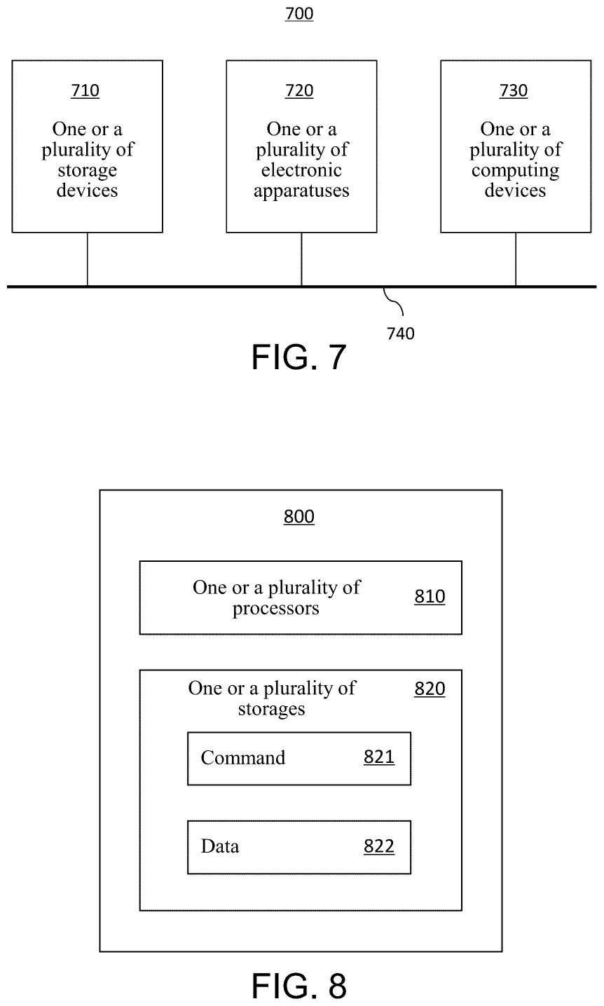

FIG. 7 is a structural view schematically illustrating at least part of a computer system 700 for assisting a user in caring for a plant according to an embodiment of the disclosure. A person having ordinary skill in the art may understand that the system 700 is merely an example and should not be viewed as limiting the scope of the disclosure or the features described herein. In this example, the system 700 may include one or a plurality of storage devices 710, one or a plurality of electronic apparatuses 720, and one or a plurality of computing devices 730, which may be communicatively connected to one another through a network or a bus 740. The one or the plurality of storage devices 710 provide storage services for the one or the plurality of electronic apparatuses 720 and the one or the plurality of computing devices 730. The one or the plurality of storage devices 710 are shown in the system 700 as a separate block from the one or the plurality of electronic apparatuses 720 and the one or the plurality of computing devices 730, but it should be understood that the one or the plurality of storage devices 710 may actually be stored on any of the other entities 720 and 730 included in the system 700. Each of the one or the plurality of electronic apparatuses 720 and the one or the plurality of computing devices 730 may be located at different nodes of the network or the bus 740 and may directly or indirectly communicate with other nodes of the network or the bus 740. A person having ordinary skill in the art may understand that the system 700 may further include other devices not shown in FIG. 7, where the different devices are located at different nodes of the network or the bus 740.

The one or the plurality of storage devices 710 may be configured to store any of the data described above, including but not limited to: the pictures, the neural network models, the samples for training the neural network models, various attributes of the plant (including species, growth stage, planting environment, etc.), the caring plan, the application program files, and other data.

The one or the plurality of computing devices 730 may be configured to perform at least part of the method 100 described above. The one or the plurality of electronic apparatuses 720 may be configured to interact with the user to provide services to the user, such as outputting an interactive question to the user or receiving a picture from the user, inputting an operable option, etc. The one or the plurality of electronic apparatuses 720 may also be configured to perform one or more steps of the method 100.

The network or the bus 740 may be any wired or wireless network and may also include a cable. The network or the bus 740 may be part of the Internet, the World Wide Web, a specific intranet, a wide area network, or a local area network. The network or the bus 740 may utilize standard communication protocols such as Ethernet, WiFi, HTTP, etc., protocols that are proprietary to one or more companies and various combinations of the foregoing protocols. The network or the bus 740 may also include but not limited to an Industry Standard Architecture (ISA) bus, a Micro Channel Architecture (MCA) bus, an Enhanced ISA (EISA) bus, a Video Electronics Standards Association (VESA) local bus, and a Peripheral Component Interconnect (PCI) bus.

Each of the one or the plurality of electronic apparatuses 720 and the one or the plurality of computing devices 730 may be configured similarly to a system 800 shown in FIG. 8, that is, having one 810 or a plurality of processors 810, one or a plurality of storages 820, a command, and data. Each of the one or the plurality of electronic apparatuses 720 and the one or the plurality of computing devices 730 may be a personal computing device for use by a user or a business computer device for use by an enterprise and may have all of the components typically used together with a personal computing device or a commercial computing device, such as a central processing unit (CPU), a storage (e.g., RAM and internal hard drive) for storing data and instructions, and one or more I/O devices such as a display (e.g., a monitor with a screen, a touch screen, a projector, a television, or other devices operable to display information), a mouse, a keyboard, a touch screen, a microphone, a speaker, and/or a network interface device.

The one or the plurality of electronic apparatuses 720 may also include one or a plurality of cameras for capturing still images or recording video streams, as well as all components for connecting these elements to each other. The one or the plurality of electronic apparatuses 720 may each include a full-sized personal computing device, but they may alternatively include mobile computing devices capable of wirelessly exchanging data with a server over a network such as the Internet. For instance, each of the one or the plurality of electronic apparatuses 720 may be a mobile phone, a device such as a PDA with wireless support, a tablet PC, or a netbook capable of obtaining information via the Internet. In another example, each of the one or the plurality of electronic apparatuses 720 may be a wearable computing system.

FIG. 8 is a structural view schematically illustrating at least part of a computer system 800 for assisting a user in caring for a plant according to an embodiment of the disclosure. The system 800 includes a processor 810 or a plurality of processors 810, a storage 820 or a plurality of storages 820, and other components (not shown) typically found in a computer or the like. Each of the one or the plurality of storages 820 may store content accessible by the one or the plurality of processors 810, including a command 821 that may be executed by the one or the plurality of processors 810 and data 822 that may be retrieved, manipulated, or stored by the one or the plurality of processors 810.

The command 821 may be any command set to be executed directly by the one or the plurality of processors 810, such as a machine code, or any command set to be executed indirectly, such as a script. The terms “command”, “application”, “process”, “step”, and “program” may be used interchangeably in the specification. The command 821 may be stored in an object code format for direct processing by the one or the plurality of processors 810 or may be stored as any other computer language, including a script or a collection of independent source code modules that is interpreted on demand or compiled in advance. The command 821 may include a command that causes, for example, the one or the plurality of the processors 810 to function as the various neural networks in the specification. The functions, methods, and routines of the command 821 are explained in detail in other paragraphs in the specification.

The one or the plurality of storages 820 may be any temporary or non-transitory computer readable storage medium capable of storing content accessible by the one or the plurality of processors 810, such as a hard drive, a memory card, ROM, RAM, DVD, CD, USB memory, writable memory, read-only memory, and the like. One or more of the one or the plurality of storages 820 may include a distributed storage system, and the command 821 and/or data 822 may be stored on a number of different storage devices that may be physically located in the same or different geographic locations. One or more of the one or the plurality of storages 820 may be connected to the one or a plurality of first devices 810 via a network and/or may be directly connected to or merged into any one of the one or the plurality of processors 810.

The one or the plurality of processors 810 may retrieve, store, or modify data 822 in accordance with the command 821. The data 822 stored in the one or the plurality of storages 820 may include at least a portion of one or a plurality of items stored in the one or the plurality of storage devices 710 described above. For instance, although the subject matter described in the specification is not limited to any particular data structure, the data 822 may also be stored in a computer register (not shown), in a relational database as a table or XML document with many different fields and records. The data 822 may be formatted in any computing device readable format, including but not limited to binary values, ASCII, or Unicode. In addition, the data 822 may also include any information sufficient to identify relevant information, such as numbers, descriptive text, proprietary codes, pointers, references to data stored in other storage, such as at other network locations, or information used by functions to compute relevant data.

Each of the one or the plurality of processors 810 may be any conventional processor, such as a commercially available central processing unit (CPU), a graphics processing unit (GPU), or the like. Alternatively, each of the one or the plurality of processors 810 may also be a special-purpose component, such as an application specific integrated circuit (ASIC) or other hardware-based processors. Although not required, the one or the plurality of processors 810 may include a specialized hardware component to perform a specific computational process faster or more efficiently, such as performing image processing on the picture and the like.

The one or the plurality of processors 810 and the one or the plurality of storages 820 are schematically shown in the same box in FIG. 8, but the system 800 may actually include multiple processors or storages that may reside within the same physical housing or within multiple different physical housings. For instance, one of the one or the plurality of storages 820 may be a hard drive or other storage medium located in a different housing than the housing of each of the one or more computing devices (not shown) described above. Accordingly, references to a processor, computer, computing device, or storage should be understood to include reference to a collection of processors, computers, computing devices, or storages that may or may not operate in parallel.

The term “A or B” in the specification and claims includes “A and B” and “A or B”, but not exclusively “A” or only “B” unless specifically stated otherwise.

In the disclosure, reference to “one embodiment” or “some embodiments” means that a feature, structure, or characteristic described in connection with the embodiment is included in at least one embodiment and at least some embodiments of the disclosure. Therefore, presence of the phrases “in one embodiment” and “in some embodiments” in various places in the disclosure are not necessarily referring to the same embodiment or embodiments. Besides, the characteristics, structures, or features may be combined in any suitable combination and/or sub-combination in one or more embodiments.

As used herein, the word “exemplary” means “serving as an example, instance, or illustration” rather than as a “model” to be exactly reproduced. Any implementation illustratively described herein is not necessarily to be construed as preferred or advantageous over other implementations. Further, the disclosure is not to be bound by any expressed or implied theory presented in the preceding technical field, background, summary, or specific embodiments.

In addition, specific terms may also be used in the following description for reference purposes only, and are thus not intended to be limiting. For instance, the terms “first”, “second”, and other such numerical terms referring to structures or elements do not imply a sequence or order unless the context clearly indicates otherwise. It should also be understood that the term “including/comprising” when used in the specification indicates the presence of the indicated feature, integer, step, operation, unit, and/or component, but does not exclude the presence or addition of one or more other features, integers, steps, operations, units and/or components, and/or combinations thereof.

In the disclosure, the terms “component” and “system” are intended to refer to a computer-related entity, hardware, a combination of hardware and software, software, or software in execution. For instance, a component may be but not limited to a process, an object, an executable state, a thread of execution, and/or a program, etc. running on a processor. By way of examples, both an application running on a server and the server may be one component. The one or more components may reside within an executing process and/or thread, and a component may be localized on one computer and/or distributed between two or more computers.

A person having ordinary skill in the art may know that the boundaries between the operations described above are merely illustrative. Multiple operations may be combined into a single operation, a single operation may be distributed among additional operations, and operations may be performed at least partially overlapping in time. Further, alternative embodiments may include multiple instances of a particular operation, and the order of operations may be changed in other various embodiments. However, other modifications, changes, and substitutions are equally possible. Therefore, the specification and drawings are to be regarded in an illustrative rather than a restrictive sense.

Although some specific embodiments of the disclosure are described in detail by way of examples, a person having ordinary skill in the art should know that the above examples are provided for illustration only and not for the purpose of limiting the scope of the disclosure. The various embodiments disclosed herein may be combined arbitrarily without departing from the spirit and scope of the disclosure. It will also be understood by a person having ordinary skill in the art that various modifications may be made to the embodiments without departing from the scope and spirit of the disclosure. The scope of the disclosure is defined by the appended claims.

What is claimed is:

1. A computer-executable method for assisting a user in caring for a plant, comprising:
identifying a species and a growth stage of a plant in a picture by a plant recognition model and generating a caring plan for the plant based on the species and the growth stage;
recognizing a health state of the plant in the picture by a health detection model, and adjusting the caring plan based on the health state; and
according to the adjusted caring plan, outputting a prompt regarding execution of a corresponding caring task at a predetermined time.

2. The method according to claim 1, further comprising at least one of following steps:
outputting an interactive question asking for additional information on a planting environment of the plant and adjusting the caring plan according to received additional information on the planting environment of the plant; and
recognizing the additional information on the planting environment of the plant in the picture by a planting environment recognition model, and adjusting the caring plan according to recognized additional information on the planting environment of the plant.

3. The method according to claim 2, wherein the planting environment comprises a caring location, and the recognizing the additional information on the planting environment of the plant in the picture by the planting environment recognition model further comprises:
in response to identifying a local feature of presence of at least one of furniture and a house around the plant and identifying an outdoor feature near the local feature of the presence of at least one of furniture and the house, determining the caring location to be outdoors;
in response to identifying the local feature of the presence of at least one of furniture and the house around the plant and not identifying the outdoor feature near the local feature of the presence of at least one of furniture and the house, determining the caring location to be indoors;
in response to identifying presence of a wall in the picture and identifying the wall as an exterior wall, determining the caring location as outdoors; and
in response to identifying the presence of the wall in the picture and not identifying the wall as an exterior wall, determining the caring location as indoors.

4. The method according to claim 2, further comprising:
in response to the planting environment of the plant being unsuitable for the plant, outputting a prompt regarding adjustment of the planting environment.

5. The method according to claim 2, wherein the outputting the interactive question asking for the additional information on the planting environment of the plant comprises:
providing one or a plurality of operable answer options for the interactive question; and
in response to a recommended answer option for the interactive question for the plant being present, selecting the recommended answer option by default.

6. The method according to claim 1, further comprising:
in response to taking a picture by the user, obtaining light intensity information by a photometer of a photographing device; and
in response to the light intensity being unsuitable for the plant, outputting a prompt regarding adjustment of the light intensity.

7. The method according to claim 1, further comprising:
identifying at least one of a size and a material of a planting container of the plant in the picture by a planting container recognition model; and
in response to at least one of the size and the material being unsuitable for the plant, outputting a prompt regarding adjustment of the planting container.

8. The method according to claim 1, further comprising:
obtaining weather information for a date with the caring task and in addition to outputting the prompt regarding the caring task, outputting the weather information on the caring task and a caring tip for the weather information.

9. The method according to claim 1, wherein the caring plan comprises the caring task and a plan execution frequency thereof, and the method further comprises:
determining a plan execution date of the caring task according to the plan execution frequency of the caring task; and
according to the plan execution date of the caring task, outputting a prompt regarding execution of the corresponding caring task on a scheduled date.

10. The method according to claim 9, further comprising:
determining whether the determined plan execution date of the caring task satisfies a condition for adjustment to a target date; and
in response to satisfying the condition, adjusting the plan execution date of the caring task to the target date,
wherein the target date comprises:
a rest day closest to the plan execution date of the caring task,
a date that does not conflict with a schedule of the user, or
a plan execution date of a second caring task closest to the plan execution date of the caring task.

11. The method according to claim 10, wherein the condition comprises a plan execution interval indicated by the plan execution frequency of the caring task being greater than 5 days and the number of days between the plan execution date of the caring task and the target date being less than 20% of the plan execution interval.

12. The method according to claim 9, further comprising:
in response to receiving a delay/skip operation for the caring task, adjusting the plan execution date of the caring task.

13. The method according to claim 1, further comprising:
regularly performing a return visit on the user to obtain a current growth state of the plant and adjusting the caring plan according to the current growth state of the plant.

14. The method according to claim 13, wherein the return visit comprises at least one of outputting a return visit question and obtaining the picture of the plant.

15. The method according to claim 1, further comprising: generating the caring plan for the plant based on the species, the growth stage, and seasons.

16. The method according to claim 1, further comprising:
in response to the species of the plant being consistent with a species of a previous plant for which a caring plan is previously generated, merging the caring plan for the plant with the caring plan for the previous plant; and
according to the merged caring plan, outputting the prompt regarding execution of the corresponding caring task at the predetermined time.

17. A computer system for assisting a user in caring for a plant comprising:
one or a plurality of processors; and
one or a plurality of storages configured to store a series of computer-executable commands,
wherein when the series of computer-executable commands are executed by the one or the plurality of processors, the one or the plurality of processors are enabled to perform the method according to claim 1.

18. A non-transitory computer-readable storage medium storing a series of computer-executable commands, wherein when the series of computer-executable commands are executed by one or a plurality of computing devices, the one or the plurality of computing devices are enabled to perform the method according to claim 1.
